(19) United States
(12) Patent Application Publication
(10) Pub. No.: US 2011/0158452 A1
(43) Pub. Date: Jun. 30, 2011

(54) MICROPHONE MODULE WITH HELMHOLTZ RESONANCE CHAMBER

(75) Inventor: HWANG-MIAW CHEN, Tu-Cheng (TW)

(73) Assignee: FOXCONN TECHNOLOGY CO., LTD., Tu-Cheng (TW)

(21) Appl. No.: 12/758,805

(22) Filed: Apr. 13, 2010

(30) Foreign Application Priority Data
Dec. 30, 2009 (CN) 200910312666.X

(51) Int. Cl. H04R 1/04

(52) U.S. Cl. 381/361

(57) ABSTRACT

A microphone module includes a shell, a circuit board located in the shell, and a microphone located in the shell and electrically connecting the circuit board. The shell includes a bottom cover and a faceplate on the bottom cover. The faceplate defines a sound hole therein. A washer is provided between the microphone and the faceplate. The washer defines a sound chamber therein. The sound chamber has a diameter exceeding that of the sound hole of the faceplate. The sound chamber communicates with the sound hole, and the sound chamber and the sound hole cooperatively form a Helmholtz resonance chamber outside of the microphone.

### BACKGROUND

1. Technical Field

The disclosure generally relates to microphones, and particularly to a microphone module with high sound quality.

2. Description of Related Art

With the continuing development of audio and sound technology, microphones have been widely used in electronic devices such as headsets, mobile phones, computers and other devices providing audio capabilities.

A typical microphone defines a resonance chamber therein. The size of the resonance chamber promotes a corresponding mass of air driven, with commensurate quality of low frequency sound transmitted. If the microphone is reduced in size, the size of the resonance chamber of the microphone and the maximum power the microphone can handle are also accordingly reduced, resulting in both a reduction in loudness as well as a poorer overall quality of sound. On the other hand, increasing the size of the microphone to increase the size of the resonance chamber is not feasible in many portable device applications.

What is needed, therefore, is a microphone module which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 is an assembled, isometric view of a microphone module in accordance with one embodiment of the disclosure.

FIG. 2 is a cross section of the microphone module of FIG. 1, taken along line II-II thereof.

FIG. 3 is an exploded, isometric view of the microphone module of FIG. 1.

FIG. 4 is similar to FIG. 3, but viewed from another aspect.

### DETAILED DESCRIPTION

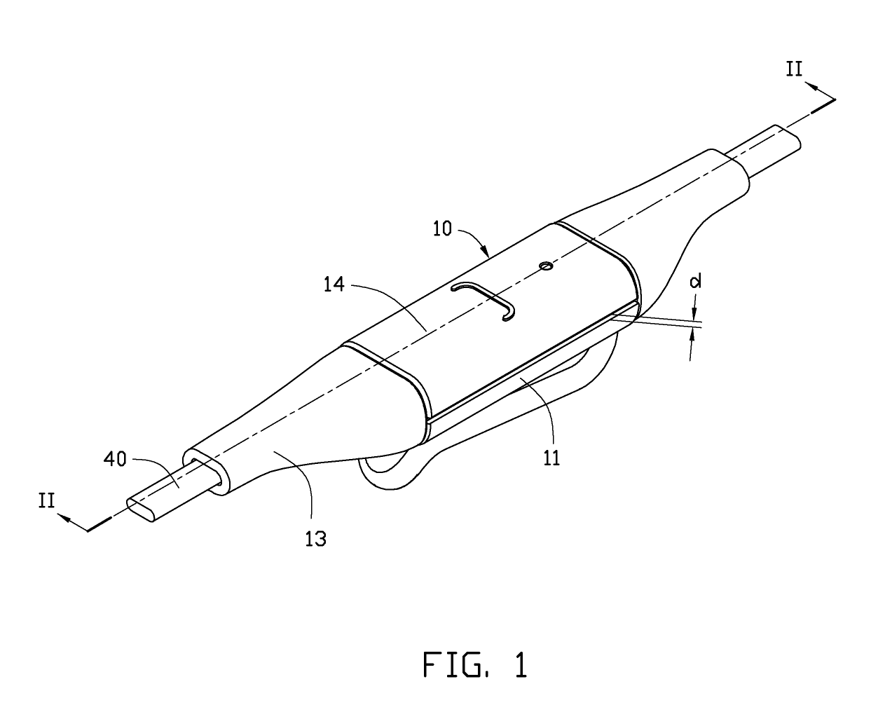

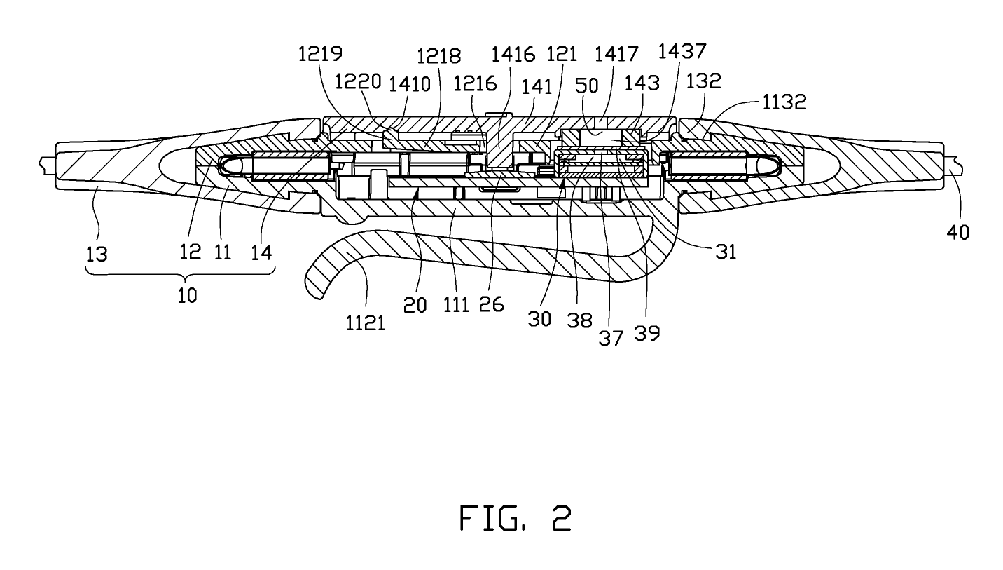

Referring to FIGS. 1 and 2, a microphone module in accordance with one embodiment of the disclosure is shown. The microphone module is configured for use in electronic devices such as headsets, mobile phones, computers, and others. The microphone module includes a shell 10, a circuit board 20 located in the shell 10, a microphone 30 located on the circuit board 20, and a cable 40 electrically connecting to the circuit board 20.

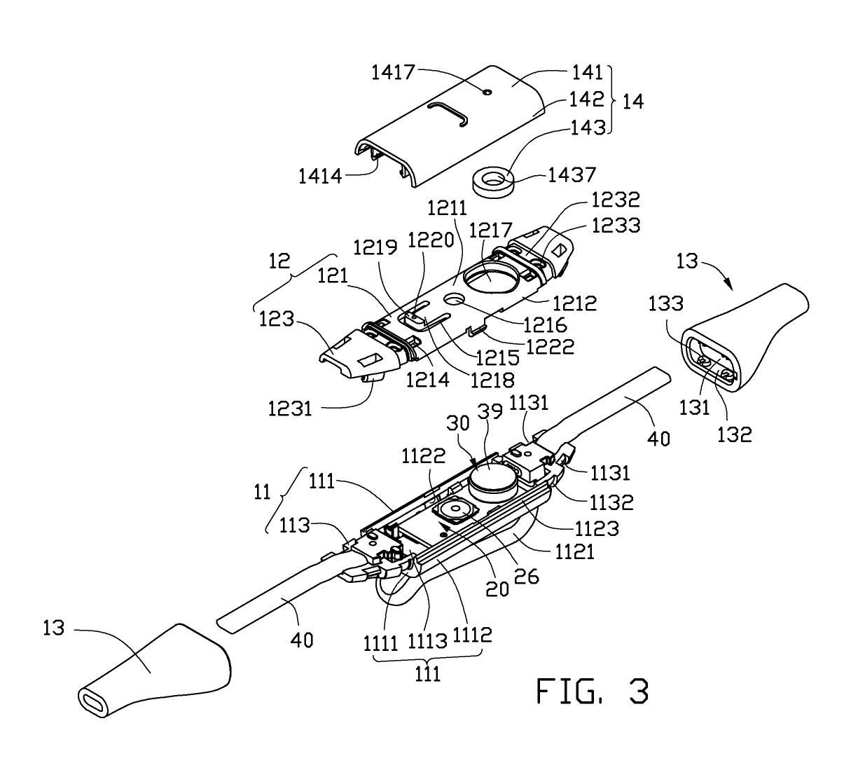

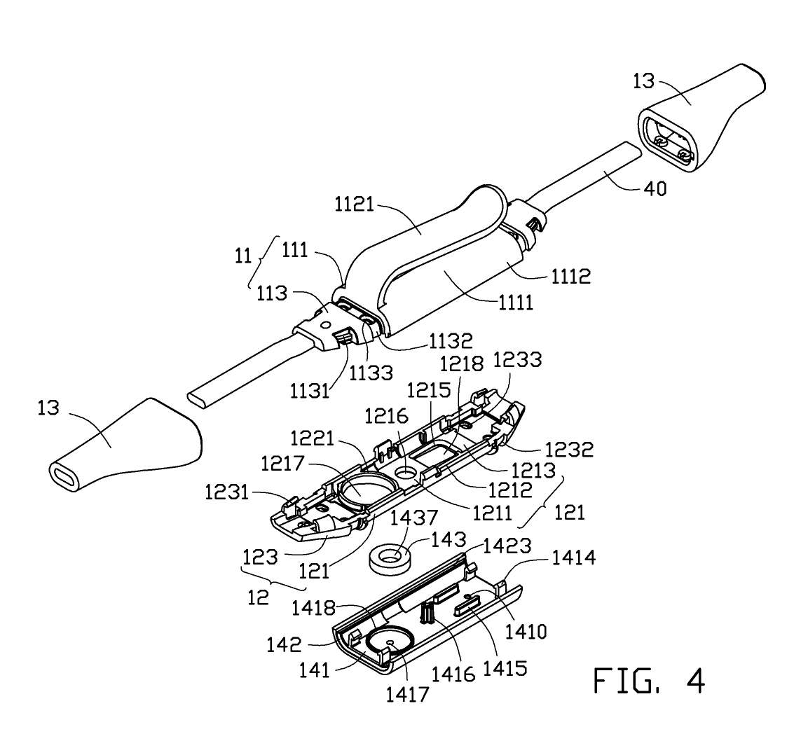

Referring to FIGS. 3 and 4, the shell 10 includes a bottom cover 11, a top cover 12 engaging the bottom cover 11, a pair of strain relief sleeves 13 respectively disposed at opposite ends of the bottom and top covers 11, 12, and a faceplate 14 located on the top cover 12.

The bottom cover 11 includes a main body 111 and two extension portions 113 at two opposite ends of the main body 111, respectively.

The main body 111 is semi-enclosed, and includes a base wall 1111, and two sidewalls 1112 extending upwardly from two opposite sides of the base wall 1111, respectively. The base wall 1111 and the sidewalls 1112 cooperatively define a receiving chamber 1113 therebetween. The base wall 1111 is substantially rectangular. A clip 1121 is integrally formed on the exterior of the base wall 1111, providing convenient location of the microphone module when in use. That is, the base wall 1111 and the clip 1121 are portions of a single, one-piece, monolithic body without any internal seams. Each of the sidewalls 1112 defines a mounting groove 1122 in an inner surface thereof. The mounting grooves 1122 communicate with the receiving chamber 1113. Each of the sidewalls 1112 forms a step 1123 at a top end thereof. An outer side of the step 1123 is lower than an inner side of the step 1123.

The extension portions 113 are integrally formed with the main body 111 as a single piece. That is, the main body 111 and the extension portions 113 are portions of a single, one-piece, monolithic body without any internal seams. Each of the extension portions 113 is tapered, with an end thereof adjacent to the main body 111 larger than an end thereof farthest away from the main body 111. Each of the extension portions 113 defines a pair of fixing grooves 1131 in two opposite lateral sides thereof, respectively. Each extension portion 113 further defines a joining groove 1132 in a bottom surface thereof (as viewed in FIG. 3). The joining groove 1132 is located adjacent to the main body 111. The joining groove 1132 is semi-annular, and extends along a circumferential direction of the corresponding extension portion 113. Each extension portion 113 further defines a pair of fixing through holes 1133 in communication with the joining groove 1132.

The top cover 12 is similar to the bottom cover 11, but further includes a main body 121 and two extension portions 123 at two opposite ends of the main body 121, respectively.

The main body 121 is semi-enclosed, and includes a top wall 1211, and two sidewalls 1212 depending from two opposite sides of the top wall 1211, respectively. The top wall 1211 and the sidewalls 1212 cooperatively define a receiving chamber 1213 therebetween.

The top wall 1211 is substantially rectangular, and defines a receiving through hole 1214 at each of four corners thereof. The top wall 1211 further defines a first through hole 1215, a second through hole 1216, and a third through hole 1217 therein. The first, second and third through holes 1215, 1216, 1217 extend through top and bottom surfaces of the top wall 1211. The first and third through holes 1215, 1217 are located at two opposite ends of the top wall 1211, respectively. The second through hole 1216 is located at the center of the top wall 1211, namely, between the first and third through holes 1215, 1217. The top wall 1211 has an elastic tab 1218 extending outward from an inner edge thereof. The elastic tab 1218 is disposed in the first through hole 1215 and is generally adjacent to the second through hole 1216. With the elastic tab 1218 disposed in the first through hole 1215, the first through hole 1215 is substantially U-shaped. A thickness of the elastic tab 1218 is substantially tapered, with a free end of the elastic tab 1218 away from the second through hole 1216 being thinner than an end of the elastic tab 1218 generally adjacent to the second through hole 1216. The elastic tab 1218 has a block 1219 protruding upwardly from the free end thereof. A lobe 1220 extends upwardly from the center of a top surface of the block 1219. The second and third through holes 1216, 1217 are circular, and the third through hole 1217 has a diameter less than that of the second through hole 1216. The top wall 1211 has an annular orienting flange 1221 extending perpendicular to an outer edge of the third hole 1217 towards the bottom cover 11.

A distance between outer surfaces of the two sidewalls 1212 of the top cover 12 is substantially equal to a distance between inner surfaces of the two sidewalls 1112 of the bottom cover 11. A mounting hook 1222 depends from a bottom end of each sidewall 1212 of the top cover 12, and is received in the mounting groove 1122 of the corresponding sidewall 1112 of the bottom cover 11.

The extension portions 123 of the top cover 12 are similar to the extension portions 113 of the bottom cover 11. Each of the extension portions 123 is substantially tapered. Each extension portion 123 defines a joining groove 1232 in a top surface thereof (as viewed in FIG. 3) adjacent to the main body 121, and a pair of fixing through holes 1233 in communication with the joining groove 1232. Each extension portion 123 has a pair of fixing hooks 1231 depending from an outer surface thereof. The pair of fixing hooks 1231 face each other, and are received in the respective fixing grooves 1131 of the extension portions 113 of the bottom cover 11.

The sleeves 13 are made of elastic material, such as rubber. Each of the sleeves 13 is substantially tapered, with an end thereof adjacent to the main body 111 of the bottom cover 11 larger than the end thereof away from the main body 111 of the bottom cover 11. Each sleeve 13 defines a substantially tapered through hole 131 therein. Each sleeve 13 has an annular joining flange 132 extending into the through hole 131 from an inner surface thereof adjacent to the main body 111 of the bottom cover 11. The joining flange 132 forms two pairs of fixing protrusions 133 symmetrically at top and bottom surfaces of an inner edge thereof.

The faceplate 14 includes a top plate 141, two side plates 142 extending respectively out from two opposite sides of the top plate 141 towards the bottom cover 11, and a washer 143 attached to the top plate 141.

The top plate 141 is substantially rectangular, and has an engaging hook 1414 depending toward the bottom cover 11 from each of four corners thereof. The engaging hooks 1414 of the top plate 141 are received in the receiving through holes 1214 of the main body 121 of the top cover 12. The top plate 141 has two elongate orienting arms 1415 and a cross-shaped (X-shaped) post 1416 all depending towards the bottom cover 11 from an inner surface thereof. The orienting arms 1415 are located at one end of the top plate 141, and are aligned with the first through hole 1215 of the main body 121 of the top cover 12. The orienting arms 1415 are spaced from each other, and are parallel to the side plate 142 of the faceplate 14. The top plate 141 defines a pit 1410 between the orienting arms 1415. The pit 1410 is aligned with the lobe 1220 of the main body 121 of the top cover 12. The post 1416 is located at the center of the inner surface of the top plate 141, and is aligned with the second through hole 1216 of the main body 121 of the top cover 12.

The top plate 141 defines a sound hole 1417 at one end thereof away from the orienting arms 1415. The sound hole 1417 extends perpendicularly through the top plate 141, and is aligned with the third through hole 1217 of the main body 121 of the top cover 12. The sound hole 1417 is circular, and has a diameter less than that of the third through hole 1217 of the main body 121 of the top cover 12. The top plate 141 has an orienting flange 1418 extending towards the top cover 12. The orienting flange 1418 is annular, and is disposed around the sound hole 1417. The orienting flange 1418 has an inner diameter exceeding that of the sound hole 1417.

The washer 143 is made of elastic material such as sponge, rubber, or another suitable material. The washer 143 is adhered to the top plate 141 in the orienting flange 1418. The washer 143 is annular, and defines a sound chamber 1437 therein. An outer diameter of the washer 143 is less than the inner diameter of the orienting flange 1418. An inner diameter of the washer 143, namely, a diameter of the sound chamber 1437, exceeds that of the sound hole 1417.

Each of the side plates 142 forms a step 1423 at a top end thereof. An outer side of the step 1423 is higher than an inner side of the step 1423. The step 1423 is matched with the step 1123 of the sidewall 1112 of the bottom cover 11.

The circuit board 20 is received in the receiving chamber 1113 of the bottom cover 11 of the shell 10. The circuit board 20 forms a switch 26 at the center of a top surface thereof, to control operation of the circuit board 20. The switch 26 aligns with the second through hole 1216 of the top cover 12 and the post 1416 of the faceplate 14 of the shell 10.

The microphone 30 is disposed on the top surface of the circuit board 20, and electrically connects to the circuit board 20. In this embodiment, the microphone 30 is an electret condenser microphone (ECM). The microphone 30 is cylindrical, and has an outer diameter less than an inner diameter of the third through hole 1217 of the top cover 12 of the shell 10. The microphone 30 defines an acoustic chamber 31 in an interior thereof, and an acoustic hole 37 in a top end thereof. The acoustic hole 37 communicates the acoustic chamber 31 with the exterior. The acoustic hole 37 and the acoustic chamber 31 cooperatively form a first Helmholtz resonance chamber 38 in the microphone 30. A tuning cloth 39, made of unwoven cloth, is arranged on the acoustic hole 37. The tuning cloth 39 cooperates with the acoustic hole 37 to improve the sound quality factor and adjust the sound sharpness of the microphone 30.

The cable 40 connects the circuit board 20 with an electronic device (not shown). Two ends of the cable 40 extend respectively through gaps (not shown) between the extension portions 113, 123 of the bottom and top covers 11, 12, and the sleeves 13.

During assembly of the microphone module, the circuit board 20 with the microphone 30 and the cable 40 is mounted in the receiving chamber 1113 of the bottom cover 11 of the shell 10, with the switch 26 and the microphone 30 on the circuit board 20 facing upwardly, and the two ends of the cable 40 extending respectively outwardly along the extension portions 113 of the bottom cover 11 of the shell 10.

The top cover 12 of the shell 10 is aligned with the bottom cover 10 of the shell 10, and brought towards the bottom cover 11 until the mounting hooks 1222 of the sidewalls 1212 of the top cover 12 are respectively received in the mounting grooves 1122 of the sidewalls 1112 of the bottom cover 11, and the fixing hooks 1231 of the extension portions 123 of the top cover 12 are received in the fixing grooves 1131 of the extension portions 113 of the bottom cover 11. A top end of the microphone 20 is received in the orienting flange 1221 of the main body 121 of the top cover 12. The second through hole 1216 of the main body 121 of the top cover 12 aligns with the switch 26 of the circuit board 20. The joining groove 1132 of each extension portion 113 of the bottom cover 11 and the joining groove 1232 of the corresponding extension portion 123 of the top cover 12 cooperatively form an annular structure. The two ends of the cable 40 extend respectively through the gaps between the extension portions 113, 123 of the bottom and top covers 11, 12. The two ends of the cable 40 are extended through the through holes 131 of the sleeves 13, respectively. The sleeves 13 are disposed around the extension portions 113, 123 of the bottom and top covers 11, 12. At this time, the joining flange 132 of each sleeve 13 is received in the joining grooves 1132, 1232 of the corresponding extension portions 1132, 1232 of the bottom and top covers 11, 12, and the fixing protrusions 133 of the joining flange 132 of each sleeve 13 are respectively fixed in the fixing through holes 1133, 1233 of the extension portions 113, 123 of the bottom and top covers 11, 12.

The washer 143 is attached to the top plate 141 of the faceplate 14, and is located in the orienting flange 1418 of the faceplate 14. The faceplate 14 is aligned with the main body 121 of the top cover 12. The faceplate 14 is pressed towards the top cover 12 until the engaging hooks 1414 of the top plate 141 of the faceplate 14 are respectively received in the receiving through holes 1214 of the main body 121 of the top cover 12. At this time, the top cover 12 is enclosed by the bottom cover 11 and the faceplate 14. The orienting arms 1415 of the top plate 141 of the faceplate 14 are received in the first through hole 1215 of the main body 121 of the top cover 12, and are respectively located at two opposite sides of the elastic tab 1218 of the main body 121 of the top cover 12. The block 1219 of the elastic tab 1218 abuts against the bottom surface of the top plate 141 of the faceplate 14. The lobe 1220 of the block 1219 is received in the pit 1410 of the top plate 141 of the faceplate 14. The post 1416 of the top plate 141 of the faceplate 14 extends through the second through hole 1216 of the top wall 121 of the top cover 12. A free end of the post 1416 farthest away from the faceplate 14 aligns with and is located adjacent to the switch 26 of the circuit board 20. The washer 143 of the faceplate 14 is received in the third through hole 1217 of the top wall 1211 of the top cover 12. The sound chamber 1437 of the washer 143 aligns with the acoustic hole 37 of the microphone 30. A bottom surface of the washer 143 is snugly fixed to the tuning cloth 39 of the microphone 30, so that the sound hole 1417 of the top plate 141 of the faceplate 14 and the sound chamber 1437 of the washer 143 cooperatively form a second Helmholtz resonance chamber 50 (see FIG. 2).

The steps 1423 of the side plates 142 of the faceplate 14 are respectively matched with the steps 1123 of the sidewalls 1112 of the bottom cover 11. The step 1423 of each side plate 142 of the faceplate 14 and the step 1123 of the corresponding sidewall 1112 of the bottom cover 11 cooperatively define a moveable gap d (FIG. 1) therebetween.

In the present microphone module, the washer 143 with the sound chamber 1437 therein is provided between the microphone 30 and the faceplate 14, and the sound chamber 1437 of the washer 143 and the sound hole 1417 of the top plate 141 of the faceplate 14 cooperatively form the second Helmholtz resonance chamber 50 outside of the microphone 30. Thereby, the microphone module makes full use of the space between the microphone 30 and the faceplate 14. This is convenient to widen the frequency bandwidth of the sound generated by the microphone module, and lower the lowest resonance frequency of the sound generated by the microphone module. Thus, the quality of the low frequency sound of the microphone module is enhanced.

In addition, the washer 143 is made of elastic material, and each side plate 142 of the faceplate 14 and the corresponding sidewall 1112 of the bottom cover 11 cooperatively define the moveable gap d therebetween. Accordingly, when the top plate 141 of the faceplate 14 is pressed, the washer 143 is squeezed by the top plate 141 and thereby deforms appropriately. At this time, the free end of the post 1416 of the top plate 141 is compelled to press the switch 26 of the circuit board 20, so as to control operation of the microphone module. When the pressure on the top plate 141 of the faceplate 14 is removed, the washer 143 returns to its original position due to its resilient rebounding force.

Furthermore, the block 1219 of the elastic tab 1218 of the top cover 12 abuts against the bottom surface of the top plate 141 of the faceplate 14. The elastic tab 1218 and the washer 143 are respectively located at the two opposite ends of the top plate 141, and the post 1416 is located at the middle of the top plate 141. Thus, not only can the faceplate 14 be handled conveniently, but the switch 26 of the circuit board 20 can also be initiated evenly with protection from damage thereto, such that the quality of the microphone module is improved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A microphone module, comprising:
a shell comprising a bottom cover and a faceplate on the bottom cover, the faceplate defining a sound hole therein;
a circuit board located in the shell;
a microphone located in the shell and electrically connected to the circuit board; and
a washer provided between the microphone and the faceplate of the shell, the washer defining a sound chamber therein, a diameter of the sound chamber exceeding that of the shell, the sound chamber communicating with the sound hole, the sound chamber and the sound hole cooperatively forming a Helmholtz resonance chamber outside of the microphone.

2. The microphone module of claim 1, wherein the microphone defines an acoustic chamber in an interior thereof, and an acoustic hole in a top end thereof, the acoustic hole communicates the acoustic chamber with the exterior, and the acoustic hole and the acoustic chamber cooperatively form a Helmholtz resonance chamber in the microphone.

3. The microphone module of claim 2, wherein a tuning cloth is arranged on the acoustic hole, and a bottom surface of the washer is snugly fixed to the tuning cloth.

4. The microphone module of claim 1, wherein the faceplate comprises an annular orienting flange depending therefrom, the orienting flange is disposed around the sound hole, the washer is located in the orienting flange, and an outer diameter of the washer is less than the inner diameter of the orienting flange.

5. The microphone module of claim 1, wherein the washer is elastic, the circuit board comprises a switch, the faceplate comprises a post extending towards the circuit board, and a free end of the post away from the faceplate is aligned with the switch.

6. The microphone module of claim 5, wherein the shell further comprises a top cover engaging the bottom cover, the top cover is disposed between the bottom cover and the faceplate, and the top cover comprises an elastic tab abutting against the faceplate.

7. The microphone module of claim 6, wherein the elastic tab and the washer are respectively located at two opposite ends of the top cover, and the post is located at the center of the top cover.

8. The microphone module of claim 7, wherein the faceplate comprises a top plate and two side plates extending from two opposite sides of the top plate, respectively, an orienting arm extends from the top plate towards the bottom cover, the orienting arm and the sound hole are located at two opposite ends of the top plate, the top cover comprises a top wall and two sidewalls extending from two opposite sides of the top wall, respectively, the top wall defines a first through hole, a second through hole, and a third through hole therein, the first and third through holes are located at two opposite ends of the top wall, respectively, the second through hole is located at the center of the top wall, and the first, second and third through holes are aligned with the orienting arm, the post and the washer, respectively.

9. The microphone module of claim 8, wherein the bottom cover comprises a base wall and two sidewalls extending from two opposite sides of the bottom surface, respectively, and each sidewall of the bottom cover and a corresponding sidewall of the top cover defines a moveable gap therebetween.

10. The microphone module of claim 8, wherein the faceplate further comprises another orienting arm, the two orienting arms of the faceplate are spaced from each other, the elastic tab of the top cover extends into the first through hole such that the first through hole is generally U-shaped, and the two orienting arms of the faceplate are received in the first through hole and are respectively located at two opposite sides of the elastic tab of the top cover.

11. The microphone module of claim 10, wherein the elastic tab of the top cover comprises a block protruding out from a free end thereof and abutting against the top plate of the faceplate.

12. The microphone module of claim 11, wherein the block of the elastic tab of the top cover comprises a lobe extending from a top surface thereof, the top plate of the faceplate defines a pit between the orienting arms of the faceplate, and the pit receives the lobe of the top cover.

13. The microphone module of claim 5, further comprising two hollow sleeves, each of the top and bottom covers comprising two extension portions at two opposite ends thereof, respectively, the sleeves disposed around the extension portions of the top and bottom covers, respectively.

14. The microphone module of claim 13, wherein each of the extension portions of the top and bottom covers defines therein a joining groove and a fixing hole therein, the fixing hole is in communication with the joining groove, each of the sleeves defines a through hole therein, a joining flange extends from an inner surface of each of the sleeves into the through hole, a fixing protrusion is formed at an inner edge of the joining flange, the joining flange is received in the joining groove of a corresponding extension portion, and the fixing protrusion is received in the fixing hole of the corresponding extension portion.
